(19) United States
(12) Patent Application Publication
(10) Pub. No.: US 2012/0278151 A1
(43) Pub. Date: Nov. 1, 2012

(54) INTELLIGENT DISCOUNT CARD SYSTEM

(76) Inventor: Scott Galit, New York, NY (US)

(21) Appl. No.: 13/281,351

(22) Filed: Oct. 25, 2011

Related U.S. Application Data
(60) Provisional application No. 61/406,542, filed on Oct. 25, 2010.

(51) Int. Cl. G06Q 30/02

(52) U.S. Cl. 705/14.23

(57) ABSTRACT

The present invention provides an intelligent discount card system for integrating with an existing bank payment network to provide for ubiquitous acceptance offered by a bank payment network while offering a real-time point of sale transaction experience, real-time discounting and financial settlement benefits typically only available through proprietary connections to retailers.

The present Application claims priority to U.S. Provisional Application Ser. No. 61/406,542, filed on Oct. 25, 2010, which is hereby incorporated by reference in its entirety.

### FIELD OF INVENTION

The present invention relates generally to the financial service and card product industries, and, more particularly, to systems, computer program products, and associated computer-implemented methods of enabling merchants, web sites, fundraising organizations, sellers of advertising, affinity groups and manufacturers the ability to offer consumer promotions, advertising and coupons that are redeemed via a discount card operating on a bank payment network.

### BACKGROUND OF THE INVENTION

One common and popular sales promotion today is the coupon. For example, a consumer sees in the newspaper a coupon offer for a $5 discount off a purchase of more than $20. In turn, the consumer goes to the retailer, purchases more than $20 of merchandise, and then presents the coupon to the cashier, qualifying for a discount of $5 which is provided immediately by the clerk at the merchant point of sale. The consumer pays only the amount of the purchase less the qualifying coupon and walks out of the store with the desired merchandise. Such coupons and savings offers are communicated to consumers in many ways, including web sites like Groupon; mobile or SMS applications; fundraising organizations; affinity or membership groups like AARP or AAA; coupon books like the Entertainment Book; local and national TV advertising; magazines; newspapers; employer offers for employees; and more.

Long known in the art, merchants use a variety of promotions to acquire new customers and attract repeat visits and purchases from existing customers. For example, an electronics merchant creates a radio commercial offering $25 off with any purchase of stereo equipment greater than $150. The consumer goes to the retailer, purchases stereo equipment for over $150 and receives with that purchase $25 of in-store credit. Rather than provide the in-store credit for use at the same time as the purchase of stereo equipment, the retailer often provides the consumer a coupon or a store gift card providing in-store credit for use during a subsequent visit. Later the consumer returns to the retailer, presents the coupon or store gift card providing in-store credit, and receives $25 off a purchase.

Also, it has been known that banks offer and sell bank card products such as debit cards, credit cards, automatic teller machine (ATM) cards, gift or prepaid cards, and combinations thereof, e.g., ATM/debit card. Because of the convenience, flexibility, and value as a tool for promotion, cards are a common tool used by retailers millions of times a year to provide consumers with rebates, in-store credit, and promotions. Such cards are often operated as store gift cards, which operate on proprietary store gift card systems. However, such gift cards are limited in use to a specific retailer and require each individual consumer to carry multiple cards, one for each merchant with an offer.

There are other ways in which merchant offers are limited today. In addition to coupons, affinity groups like AAA which offer merchant advertising and discount offers to their members have no way of effectively tracking and reporting on the redemption of such offers. Similarly, at online web sites where physical world merchants such as a local flower shop advertise their services to consumers, the merchant can ascertain how many consumers have seen their advertisement and subsequently searched on their web site, but there is limited ability for the merchant to ascertain which consumers then complete a purchase in the physical world, how much they spend, or anything else about such consumer. If the retailer is an e-commerce retailer, the web site is typically able to link the consumer from the originating site to the e-commerce site and the e-commerce retailer is able to identify which consumers have come from which web sites and how much in turn they have purchased, which enable the referring site to provide very detailed data and the e-commerce merchant to perform very sophisticated Return-on-Investment (“ROI”) analysis on their advertising spend on web sites. Physical world merchants are able to take advantage of such advertising media, but are unable to track activity. TV, magazines, and affinity channels, among others, are all able to provide advertisers with access to consumers, but are unable to deliver sufficient data to support sophisticated ROI analysis by merchants.

As a result, manufacturers and merchants, especially physical world merchants, spend significant sums attracting consumers through various media and affinity channels and have limited ability to measure the success of their investments. It is further known for companies to use bank payment systems to provide back-end financial processing, data processing, and account tracking services to various retailers to enhance business opportunities and consumer relationships with retailers.

Those skilled in the art have long recognized that Bank payment networks, such as Visa and MasterCard, have technical and financial settlement connections to millions of retailer locations, offering ubiquitous access to such locations by using cards that operate pursuant to the standards and protocols set by such bank payment networks. Those skilled in the art also have recognized that such standards and protocols of the existing bank payment network technical and financial settlement connections impose significant limitations regarding the use of bank payment networks to create highly functional new consumer products such as those described herein. Those skilled in the art have also long recognized that one can create almost any new product for use at a merchant point of sale by establishing a proprietary technical and financial settlement connection to a retailer; however the technical, contractual, implementation, financial and operational requirements of such a proprietary integration make it extremely expensive and highly impractical to create a new product that works across the millions of merchant locations that already connect to the existing bank payment networks.

For example, Groupon offers consumers discount coupons for use at hundreds, if not thousands of merchant locations. Groupon has implemented it's product as a paper voucher or coupon because the limitations of the point of sale systems and the network connections make it impractical to utilize a bank payment network and the cost, time and complexity to establish a proprietary technical and financial settlement connection to each retailer is cumbersome, time consuming and expensive. As a result, Groupon uses paper rather than an electronic system, which would offer greater security, enhanced tracking and reporting, among other benefits.

The invention contemplated herein, through the unique combination of the intelligent discount card processing system and proprietary method for integrating with the existing bank payment network enables for the first time the creation of a discount card system that provides for the ubiquitous acceptance offered by a bank payment network while offering the real-time point of sale experience, real-time discounting and financial settlement benefits typically only available through proprietary connections to retailers.

### SUMMARY OF INVENTION

In view of the above, Applicant has recognized numerous limitations that impede the ability of manufacturers and merchants, particularly physical world merchants, from effectively measuring their advertising investments and limits the ability of advertising supported businesses, such as newspapers, web sites and TV stations, from delivering a measurable ROI for the advertiser comparable to what would be available for e-commerce advertisers and merchants. For example, a web site can inform a merchant regarding the number of visitors that saw an advertisement for that merchant, and even how many consumers have clicked on an advertisement. But the web site is unable to inform the merchant how many consumers then actually completed a purchase at the merchant. An additional limitation that Applicant has recognized is the ability to ensure a coupon is only used by the consumer for whom it was intended. A merchant may offer a coupon on a web site, but once the coupon is printed and available for use, there is limited ability to ensure it isn't copied or used by consumers different than originally intended. This is very common on web sites that aggregate and promote current offers and promotion codes for all consumers to use to save money at merchants, regardless of whether the promotion code was intended for use by specific targeted customer segments. As a result, merchants are often providing unintended discounts to certain consumers, which reduces overall margin for the merchant.

Applicant recognizes that current advertising models result in at least four distinct limitations for manufacturers and merchants, particularly physical world merchants, as well as advertising supported businesses. First, advertisers don't typically know what consumers have viewed an offer. Second, merchants have limited ability to know which of the consumers that view the offer choose to participate in the offer and demonstrate intent to use it. Third, merchants have limited ability to determine which consumers actually redeem an offer, for how much and when those offers are redeemed. Finally, merchants have limited ability to accurately measure the full usage, effectiveness and ROI of their campaigns. Embodiments of a discount card, as contained herein, for example, include a web site branded card, affinity card, employee card and membership card. According to embodiments of the present invention, it has been recognized that a discount card can be offered, for example, by an affinity group to its membership that enables those members to benefits from discounts, offers and promotions at participating merchants and provides accurate reporting to the merchants and members regarding the amount, timing and value of the discounts redeemed or an employer seeking to provide discounts to employees. Embodiments of the current invention contemplate using a bank payment network (for example, American Express, Discover, MasterCard and Visa), to provide for the ability for any merchant that accepts typical bank payment network cards such as debit, credit and prepaid cards, to accept discount cards per the current invention. The discount card, according to embodiments of the present invention, has numerous other features and benefits, including the ability to determine what consumer is participating in a given offer; when such consumer has selected to receive such offer; when such consumer has redeemed the offer; appropriate settlement and reporting to ensure all parties have paid and/or received the correct amount of funds pursuant to such discount, offer or promotion.

Embodiments of the present invention, for example, include a system using the existing bank payment networks, as understood by those skilled in the art, and point-of-sale (POS) infrastructure, as understood by those skilled in the art, to issue discount cards that are able to be accepted at any merchant that participates in that bank payment network. Embodiments of the present invention also include software, or program product stored on a tangible computer memory media as a set of instructions, operable on a computer to cause the instructions to be executed by the computer, and used to manage a purchase transaction. A consumer, for example, presents the card at the POS. Then a clerk at the retailer or the consumer swipes the card, making an authorization request of an open payment network. The network routes the request to a discount card account system connected to the bank payment network providing the discount card and services. The discount card account system then processes the request and provides the authorization response via the open payment network to the acquiring processor, which returns the message in turn to the merchant's POS.

Embodiments of the current invention rely on a transaction type called a partial approval transaction, as understood by those skilled in the art. Under such partial approval transaction, a merchant's POS system will submit a request to a bank payment network seeking authorization for a complete consumer purchase, but is able to accept a response back that indicates that the card presented by the consumer contains less than the full value requested for the purchase. The merchant's POS is then able to perform what is called a split-tender transaction, as understood by those skilled in the art, which requests the consumer to complete the purchase by presenting an additional form of payment to pay for the remaining balance of the purchase. For example, under embodiments of the current invention, a consumer visits a store and is eligible for a $5 discount off a $50 minimum purchase. The consumer brings to the register goods that in total cost $55. The consumer hands the clerk the discount card, and the clerk swipes the discount card through the merchant's POS. The POS receives a partial approval response from the discount card account system for a $5 purchase. The merchant POS system recognizes that an additional $50 is required to complete the purchase and the clerk is prompted to ask the consumer to provide an additional $50. The consumer may complete this purchase with credit, debit, cash, check, food stamp or any other tender type accepted by that merchant. In this way, the consumer has received the $5 discount immediately at the point of sale and is only required to pay the remaining balance.

In the preferred embodiment of the current invention, the discount card will be issued on a bank payment network and use an authorization-only Bank Identification Number (a “BIN”). By supporting a partial approval transaction on an authorization-only BIN, the consumer is able to complete a purchase and receive an immediate discount for a qualifying purchase at a participating merchant as described above. However, the merchant will not actually be paid pursuant to standard bank payment network settlement processes. As a result, consumers and merchants are able to accurately transact and complete purchases at the point of sale, but the merchant does not receive payment for such discount, offer or promotion from the bank payment network. For example, in the above example where the consumer receives a $5 discount on a $55 purchase, if the consumer pays the $50 owed with a credit card, the merchant will receive from the bank payment network payment for the $50 less any applicable bank payment network fees. As the merchant has provided the $5 offer to the consumer with the discount card, there is no need for funds to move, which would be the equivalent of the merchant paying itself. The discount card program administrator will provide reporting to the participating retailer to enable the retailer to see how many participating discounts, offers and promotions were redeemed and to ensure the amounts correspond to the amount calculated by the point of sale.

In an additional embodiment of the present invention, the discount card is issued on a bank payment network using a traditional settling BIN. In such embodiment of the current invention, the amount that is approved pursuant to the discount card does in fact settle through the bank payment network in accordance with the appropriate clearing and settlement process maintained by the bank payment network. In such embodiment, the merchant receives payment for the discount, offer or promotion. Such funds are collected by the bank payment network and must be paid in full by the discount card program administrator. As a result, this embodiment of the current invention requires the discount card program administrator to provide for the availability of such funds for the bank payment network. Such funds can be made available, among other additional options, by advance funding by the merchant provided to the discount card program administrator; a wire transfer by the merchant to an account designated by the discount card program administrator; a reserve account; a request via the bank Automated Clearing House System (“ACH”) to pull funds from a bank account controlled by the merchant; extension of credit to the merchant or by the discount card program administrator assuming the risk and providing the funds on the merchant's behalf.

In an additional embodiment of the present invention, the discount, offer or promotion to the consumer is offered by a company other than the merchant where it will be redeemed. In this embodiment, the funding of the offer must be made by such third party and will be facilitated by the discount card program administrator. For example, an auto manufacturer might offer $25 off a purchase at a participating gas station to all consumers who test drive a car on a given day. In such embodiment, the gas station will need to be compensated for the purchases made by the discount cardholders and funding will be provided by the auto manufacturer. If the program is operated according to an authorization-only BIN on the bank payment network, payment for the discount, offer or promotion will be made directly to the participating merchant by the discount card program administrator pursuant to transaction reports. If the program is operated on a traditional settling BIN on a bank payment network, the payment will be received automatically by the merchant as part of the traditional bank payment network settlement process. Such funds can be made available by the provider of the offer to the discount card program administrator, among other additional options, by advance funding by the offer provider to the discount card program administrator; a wire transfer by the offer provider to an account designated by the discount card program administrator; a reserve account; a request via the bank Automated Clearing House System (“ACH”) to pull funds from a bank account controlled by the offer provider; extension of credit to the offer provider or by the discount card program administrator assuming the risk and providing the funds on the offer provider's behalf.

Embodiments of the present invention also include software, or program product stored on a tangible computer memory media as a set of instructions, operable on a computer to cause the instructions to be executed by the computer, and used to manage a purchase transaction. A consumer, for example, presents the card at the POS. Then a clerk at the retailer or the consumer swipes the card, making an authorization request of a bank payment network. The network routes the request to the discount card account system providing the discount card and services. The discount card account system then processes the request and provides the authorization response via the bank payment network to the acquiring processor. As understood by those skilled in the art, Automated Clearing House (ACH) is the name of an electronic network for financial transactions in the United States, regulated by the Federal Reserve,

Embodiments also can use standard ACH file payments or wire transfers to settle accounts with the retailer and the open payment network. Embodiments of the present invention include a computer-implemented method of funding a discount card. The computer-implemented method, for example, includes receiving one or more instructions from an advertising site or participating provider of discounts, offers or promotions to register the selected offer, discount or promotion for the consumer into his or her discount card account. According to the embodiments of the present invention, the discount cards may or may not be bank products subject to federal banking laws and regulations. The computer-implemented method continues with the discount card account system recording each relevant offer in the discount card account of the relevant consumer. Next, the consumer participates in the discount, offer or promotion by making a qualifying purchase and using the discount card at a participating merchant. When the consumer attempts to make a purchase from the participating retailer using one or more discount cards as payment, authorization is requested of the discount card account system via a bank payment network and a full or partial approval is provided, as appropriate. In one embodiment of the current invention in which the discount card is issued using an authorization-only BIN on the bank payment network, the merchant receives no funds for the qualifying purchases. In an additional embodiment of the current invention in which discount cards are issued using a traditional settling BIN, the retailer is transferred funds from the bank payment network in response to the approved consumer purchase using the discount card. In this embodiment, the bank payment network collects funds from the account at a bank associated with the discount cards to satisfy the consumer purchase using the discount card as payment.

In addition, embodiments of the present invention provide, for example, a system for providing ways for discounts, offers and promotions to be loaded into a consumer's discount card account. The system can include a first computer associated with a web site defining a web site computer. The web site computer is positioned to deliver advertisements to consumers who visit the site. A consumer that wishes to participate in an offer presented on the web site would select the offer from the web site provided by one web site computer and what is likely a second web site computer would subsequently deliver electronic instructions to the discount card account system to make the selected discount, offer or promotion available to such consumer. An additional embodiment of the current invention would include an affinity group providing instructions, which are captured by a computer connected to the discount card account system, that makes a discount, offer or promotion available to all members of the affinity group. For example, AAA might make available to all AAA members an offer for 10% off every purchase at Disney properties. Such discounts, offers and promotions may be defined by or limited by many different offer criteria, including merchant; merchant type; location; zip code; individual consumer characteristics such as gender, age and state; time of day; day of week; minimum purchase amount; and number of times offer can be redeemed. In the embodiment of the current invention, the discount card account system will only reply with a full or partial approval to an authorization request originated by a merchant via a bank payment network if the request satisfies the offer criteria that have been specified and recorded in the discount card account system.

A second computer associated with the discount card account system defines a computer which is positioned to manage an account associated with at least one discount card. The system can also include a POS terminal having a processor defining an acquiring processor, and the POS terminal being associated with a participating merchant. A bank payment network can be in communication with the merchant computer and the discount card account computer and positioned to receive authorization requests for a consumer purchase using one or more discount cards to redeem qualifying offers, discounts and promotions. The requests, for example, can be captured by the acquiring processor of the POS terminal associated with the merchant to thereby route the request to the discount card account computer through the bank payment network. The bank payment network, as understood by those skilled in the art, also can receive an authorization response from the discount card account computer, transfer funds to the merchant from the bank payment network in response to an authorized consumer purchase using the discount card as payment, and collect funds from the account at a bank associated with at least one discount card to satisfy the authorized consumer purchase using the discount card as payment. The system can further include a computer program product associated with the discount card account computer, stored on a tangible computer memory media, operable on a computer, and used to manage discount card transactions. The computer program product has a set of instructions that, when executed by the computer, cause the computer to perform the operations of: authorizing full and partial approval purchase requests to use of one or more discount cards as the equivalent of a coupon to reduce the amount of payment the consumer must make for a consumer purchase from the merchant via a bank payment network, transferring funds to the bank payment network from the account at a bank associated with at least one discount card issued on a traditional settling BIN to satisfy authorized consumer purchases using the discount card as payment, and receiving funds into an account at a bank associated with the discount cards on behalf of the merchant for one or more of the following: payment for at least one discounts, offers or promotions, payment for consumer purchases using one or more discount cards, and payment for the value remaining on at least one discount card. The instructions can also include debiting from the account at a bank associated with at least one discount card of the remaining value for at least one expired discounts, offers or promotions on discount cards to thereby establish a credit for the discount card program administrator. That is, the instructions can include sweeping the account of the funds associated with the expired discounts, offers or promotions. In addition, embodiments of the present invention include systems, program products, and associated computer-implemented methods of providing multi-party discount, offer and promotion opportunities that include cross-party settlement, reporting and funds movement managed and coordinated by a discount card account system.

In additional embodiments of the present invention, the discount card may be presented in a form other than a typical discount card or even physical media. in additional embodiments of the current invention, the discount card may be a membership card, loyalty card, fob, mobile phone, mobile application, bar code, virtual account, RFID sticker or any other form factor and/or information capable of originating a transaction at a merchant point of sale system and therefore connecting to a discount card account system for authorization.

An additional embodiment of the current invention enables consumers that are members of social media, including twitter, facebook and others, to participate using discount cards in discounts, offers and promotions that enable groups of consumers to each participate in an offer, discount or promotion that has been identified by one member and shared with additional members of the same social network. Such social network participation might include, for example, maximum or minimum requirements that would apply across an entire campaign. For example, a merchant might offer consumers 25% off a minimum purchase of $100 if a minimum of 100 consumers participate. In another example, a merchant might offer a 10% discount for the first 500 social network members that register for and make a purchase at the participating retailer using the eligible discount card. In these examples, the discount card account system manages all campaign settings and limits to ensure only eligible consumers receive the discounts, offers and promotions for which they actually qualify.

In an additional embodiment of the current invention, the discount card account system receives product information, often described as SKU-level information by those skilled in the art, from participating merchants. Such information may be provided either a) through the bank payment network, either (i) during the authorization request or (ii)in a subsequent bank payment network transmission, or b) such information may be transmitted directly by the merchant, or a third party that collects such information from merchants, to the discount card account system. In this embodiment of the present invention, the discount card account system matches the SKU data to the purchase information and the consumer profile to determine whether any product specific offers are available to such consumer. If the SKU information is provided during the authorization process, such information may be included in the authorization decision that is made by the discount card account system. If the SKU information is received by the discount card account system subsequent to the completion of the authorization transaction, the value for the product discount, offer or promotion for the qualifying discount cardholder will be delivered to that consumer subsequent to the completion of the purchase. Such value could be delivered in the form of additional discounts loaded on the discount card, a rewards account, electronic payment to a bank account, delivery of a physical or electronic gift card or any other way to provide value to a consumer.

An additional embodiment of the current invention contemplates adding a unique bar code to each consumer's card in addition to the magnetic stripe that operates on the bank network system as contemplated herein to enable a bar code scanning system, such as is typically employed at many retailers to scan both products and loyalty cards, to create an additional identification method for tracking and properly transacting with each individual consumer. Such bar code system would compliment the bank payment network system, and adding such capability provides additional merchant-specific processing flexibility that can offer enahnced product level offers for consumers as well as merchant-specific tracking, data aggregation and reporting. Providing such additional capability as well as options to merchants that participate creates additional value for consumers as well as the merchants and manufacturers that can participate.

According to the embodiments of the current invention, manufacturers and merchants, particularly physical world merchants, and ad-supported businesses are able to deliver on the benefits of electronic media and electronic commerce to physical world commercial activity. As a result, advertisers are able to receive substantially more information regarding their marketing expenditures and more effectively target and measure such spend, and ad supported businesses are able to offer additional valuable marketing opportunities and information to their advertisers.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic flow diagram of a computer-implemented method of a consumer accepting a discount offer presented on a web site to a discount card account system according to an embodiment of the present invention;

FIG. 2 is a schematic flow diagram of a computer-implemented method of a consumer accepting a discount offer presented on a TV show to a discount card account system according to another embodiment of the present invention;

FIG. 3 is a schematic flow diagram of a computer-implemented method of a consumer receiving a discount offer from an affinity group with which the consumer is affiliated to a discount card account system according to yet another embodiment of the present invention;

FIG. 4 is a schematic flow diagram of a computer-implemented method of a consumer completing a purchase at a merchant point of sale system with the authorization of partial payment by the merchant system of the discount card according to an embodiment of the present invention using an authorization-only BIN;

FIG. 5 is a schematic flow diagram of a computer-implemented method of a funds flow process for the settlement of a discount card transaction that is operated on a traditional bank payment network BIN;

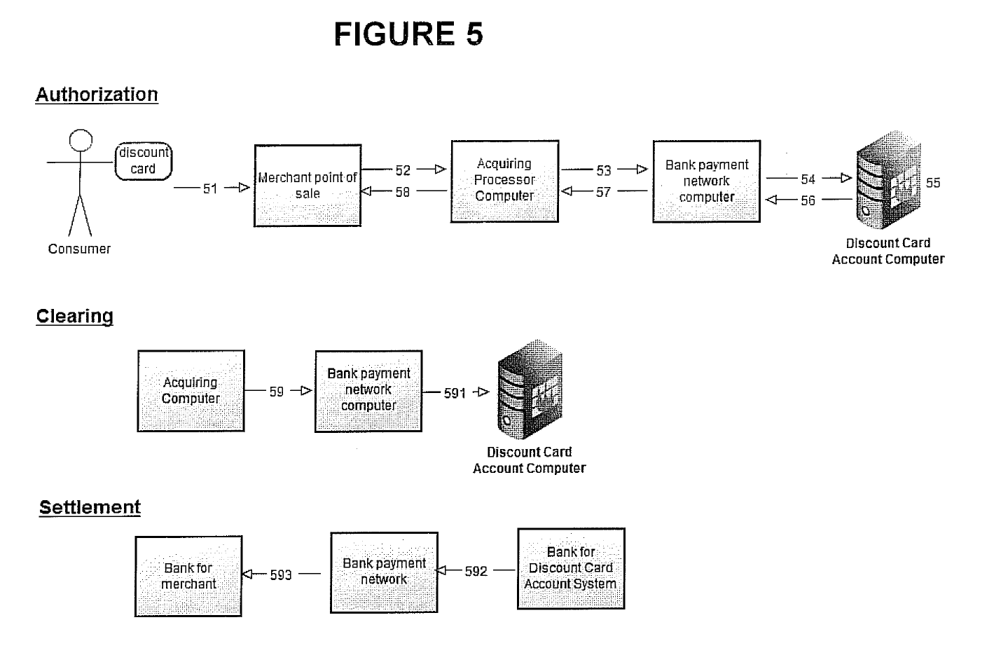

FIG. 6 is a schematic block diagram of a discount card account in the discount card account system according to a embodiments of the present invention;

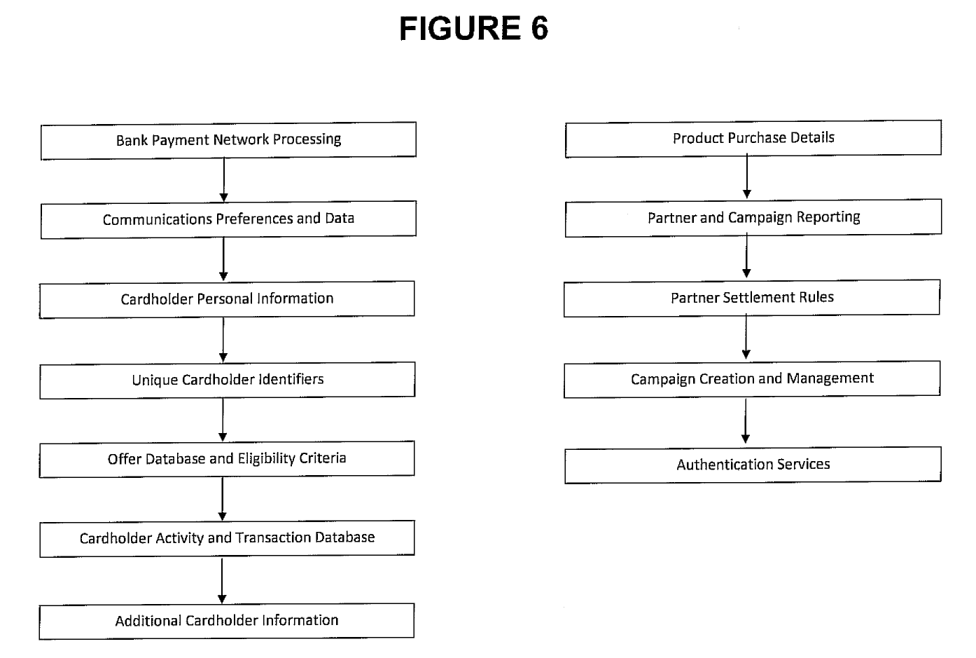

FIG. 7 is a schematic flow diagram of a computer-implemented method of a merchant providing SKU information to the discount card account system;

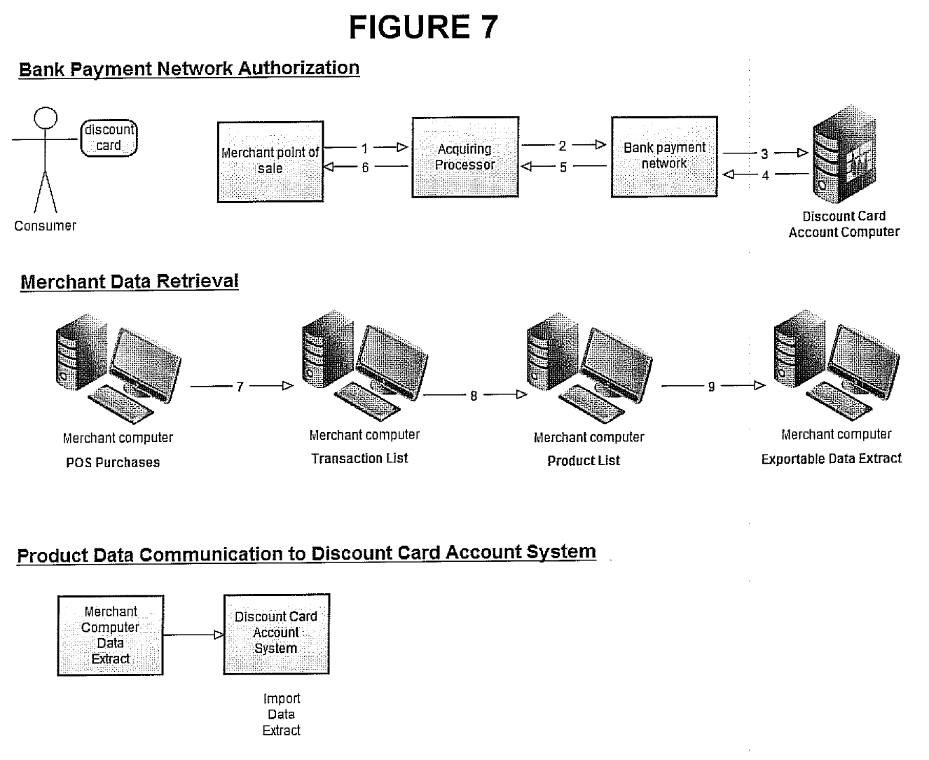

FIG. 8 is a schematic flow diagram of a computer-implemented method of an authorization request receiving an approval of $0 to record the consumer's purchase at the selected merchant.

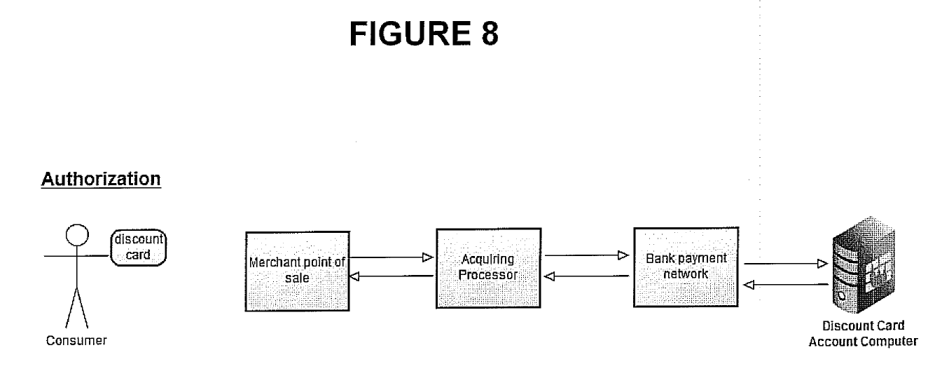

### DETAILED DESCRIPTION

The present invention provides a system for providing a discount card, the system comprising: a first computer associated with a discount card account system defining a discount card account system computer, the discount card account system computer having memory, associated with an electronic communications network and in communication with a bank payment network, and positioned to manage an account associated with at least one discount card; and a computer program product associated with the discount card account computer, stored on a tangible computer memory media, operable on a computer, and used to manage discount card transactions, the computer program product comprising a set of instructions that, when executed by the computer, cause the computer to perform the operations of: processing of merchant discounts, offers or promotions for one or more discount cards by the discount card account computer; the discount, offer or promotion information being received by the discount card account computer from a second computer associated with a web site defining a web site computer; the discount, offer or promotion being associated by the discount card account system with the correct consumer discount card account and the correct offer campaign; authorizing purchase requests to use one or more discount cards as payment for the consumer purchase from a merchant via a bank payment network using an authorization-only BIN by a discount card account system; such authorization response being an approval for a partial amount that is less than the full amount of the consumer purchase, such amount that is equal to the amount of a qualifying discount, offer or promotion at the specific merchant; debiting the discount card account in the discount card account system for the appropriate amount corresponding to approved discounts, offers and promotions; and performing a proprietary, non-bank network based financial settlement process for all relevant funds requirements, fees and other financial considerations as established between the discount card program administrator and participating merchants.

According to one embodiment of the present invention, the provided system is comprised wherein at least one discount card receive discount, offer and promotion information associated with an individual consumer discount card account from one or more of the following: web site, yellow pages, affinity group, employer, social networking site, mobile phone, mobile application, TV station, text message, email, radio station, newspaper, coupon, fundraiser, coupon books, smart posters, geolocation-based offers, SMS or any other advertising or merchant offer-supported business and technology. According to an alternative embodiment, the consumer does not present a physical card for payment but presents the merchant point of sale with an alternative consumer identifier capable of originating a POS authorization request, which could be a membership card, loyalty card, fob, mobile phone, mobile application, bar code, virtual account, RFID sticker or any other form factor and/or information capable of originating a transaction at a merchant point of sale system and therefore connecting to a discount card account system for authorization. Still another embodiment provides the system wherein the discount card is issued using a traditional financial BIN that participates in the bank payment network and settles all approved transactions from an account at a bank associated with the discount card program administrator. Yet another embodiment provides wherein the offer, discount or promotion is provided by a third party other than the redeeming merchant wherein the third party must provide funds to enable the discount card program administrator to pay the merchant for goods delivered pursuant to transactions approved by the discount card account system. Still according to another embodiment, at least one discount card have indicia thereon defining a partner brand and such brand being different than indicia of the merchant accepting the card, such that an affinity group, TV station, web site or other partner can provide the product to its customers or members and reinforce its brand. The present invention also contemplates wherein the discount card account system receives the partial approval authorization request from the merchant point of sale system or the acquiring processor. According to another embodiment, in addition to the traditional point-of-sale transaction that occurs through the bank payment network, the discount card account system receives information regarding the products that are purchased at the merchant and the discount card account system records such product purchase information with the appropriate consumer discount card account and matches those products to offers available to the participating consumer in the appropriate discount card account. The present invention also provides the system wherein the financial settlement process is facilitated by a bank payment network, or a bank, based on transaction information provided and instructions provided to support the discount card program, but such financial settlement process is not the standard process facilitated and managed by such bank payment networks, but is provided as a service in support of such discount card program.

The present invention also provides a computer program product, stored on a tangible computer memory media, operable on a computer, and used to manage discount card transactions, the computer program product comprising a set of instructions that, when executed by the computer, cause the computer to perform the operations of: authorizing purchase requests to use one or more discount cards as payment for a consumer purchase from the retailer via a bank payment network by a discount card account computer where the approval response is a partial approval with a value of $0, which is used to track consumer purchasing activity and deliver an approval to such participating retailer, but not impact the purchase amount to be completed by that consumer at the point-of-sale. According to one embodiment of this invention, the provided computer program product is wherein the operations further comprise a partial approval of value greater than zero but less than the purchase amount, in a value that does not directly correspond to an offer but is meant to communicate an approval to the merchant point of sale and a nominal transaction amount such that the bank payment network and the merchant point-of-sale will not reject or edit such transaction.

The present invention also provides a computer-implemented method of creating a network of merchants that share product information with a discount card program administrator in return for compensation, the computer-implemented method comprising: merchant processing discount card transactions; merchant providing the discount card account system with information on a scheduled periodic basis in a predefined computer-readable format that provides product information regarding the purchases represented by the discount cards accepted at such merchant; the discount card account system recording the product purchases and matching such purchases in the discount card account system to the appropriate consumer discount card account; the discount card account system calculating the discounts to be received by each participating and eligible consumer for specific product purchases; and the discount card account system calculating the amount to be paid as a commission to the participating merchant that provided the qualifying product purchase information to the discount card account system. According to one embodiment of this invention, the provided computer-implemented method is wherein the product information from the merchant is provided through the bank payment network and received and used by the discount card account system to calculate the appropriate discount or offer for the eligible consumer discount cardholder as well as calculate the commission amount to be paid to the merchant that provides the product information used by the discount card account system to calculate the qualifying discount, offer or promotion. According to another embodiment, the merchant computer systems use the discount card account number as a unique identifier to search for purchases in its computer systems made by such consumers and extracts the associated product information for those consumers and delivers that information to the discount card account system. Still another embodiment provides that the merchant delivers product information to the participating bank payment network. Yet another embodiment provides that the card contains a bar code either on its own or in conjunction with a magnetic stripe, with the barcode being a unique identifier for the individual that will remain unique across merchants per standards, such as UPC codes.

The present invention also provides a system for providing a discount card that is used by groups of consumers, either a group of unaffiliated consumers like group buying services like Groupon or consumers who are somehow connected via social networking, such as Facebook or Twitter, the system comprising: a first computer associated with a discount card account system defining a discount card account system computer, the discount card account system computer having memory, associated with an electronic communications network and in communication with a bank payment network, and positioned to manage an account associated with at least one discount card; and a computer program product associated with the discount card account computer, stored on a tangible computer memory media, operable on a computer, and used to manage discount card transactions, the computer program product comprising a set of instructions that, when executed by the computer, cause the computer to perform the operations of: processing of merchant discounts, offers or promotions for one or more discount cards by the discount card account computer; the discount, offer or promotion information being received by the discount card account computer from a second computer associated with a web site defining a web site computer; the discount, offer or promotion being associated by the discount card account system with the correct consumer discount card account and the correct offer campaign; the discount, offer or promotion being somehow connected to the behavior of a group of consumers, where all the consumers participating in the group receive the same offer and the nature of the offer itself is somehow dependent on the group participation; authorizing purchase requests to use one or more discount cards as payment for the consumer purchase from a merchant via a bank payment network using an authorization-only BIN by a discount card account system; such authorization response being an approval for a partial amount that is less than the full amount of the consumer purchase, such amount that is equal to the amount of a qualifying discount, offer or promotion at the specific merchant; debiting the discount card account in the discount card account system for the appropriate amount corresponding to approved discounts, offers and promotions. According to one embodiment, the total purchase amount for the consumer purchase at the participating retailer is made by the discount card account computer through the participating bank payment network for all purchases that meet qualifying criteria of the discount offered. According to yet another embodiment, the consumer prepays the discount card program administrator for all or a portion of the purchase amount at the participating retailer to qualify for the discount offered. Still another embodiment provides that the discount offered by the retailer increases as more members of the group commit to defined purchase criteria set by the retailer. According to even yet another embodiment, the retailer offers a lower price or additional benefits, rather than discounts or coupons, as more members of the group commit to defined purchase criteria set by the retailer. Another alternative embodiment provides that the authorization requests are made using a traditional BIN on the bank payment network.

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

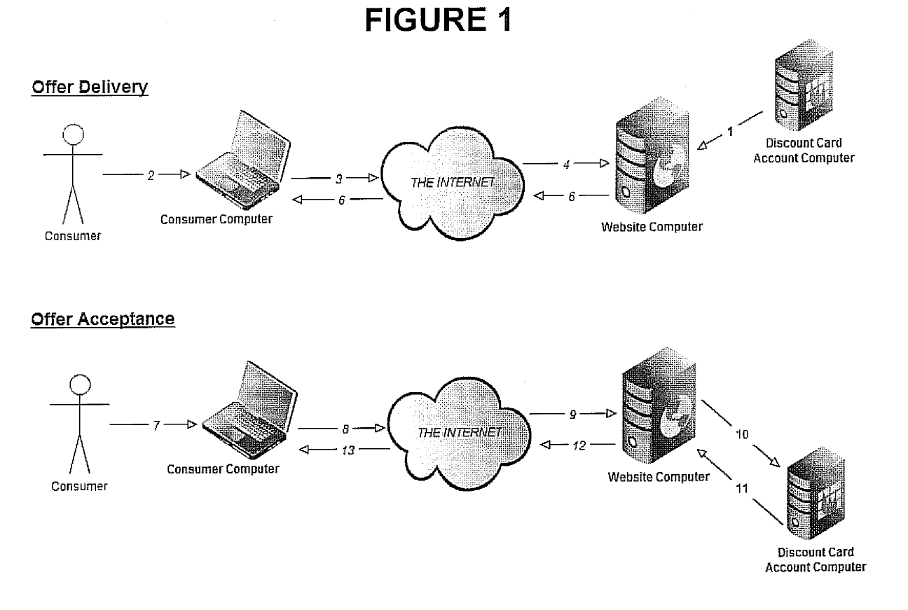

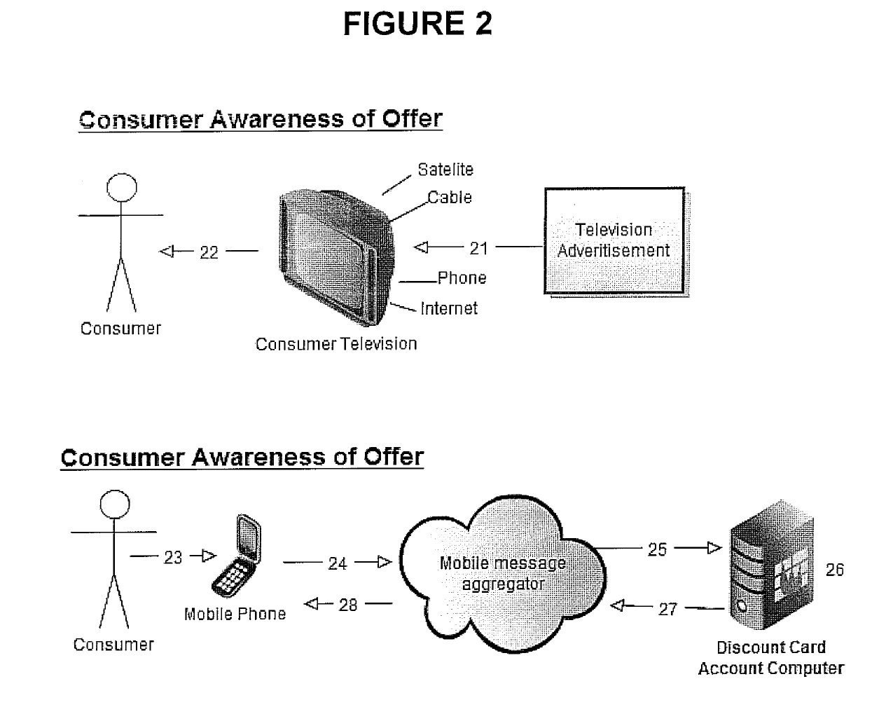

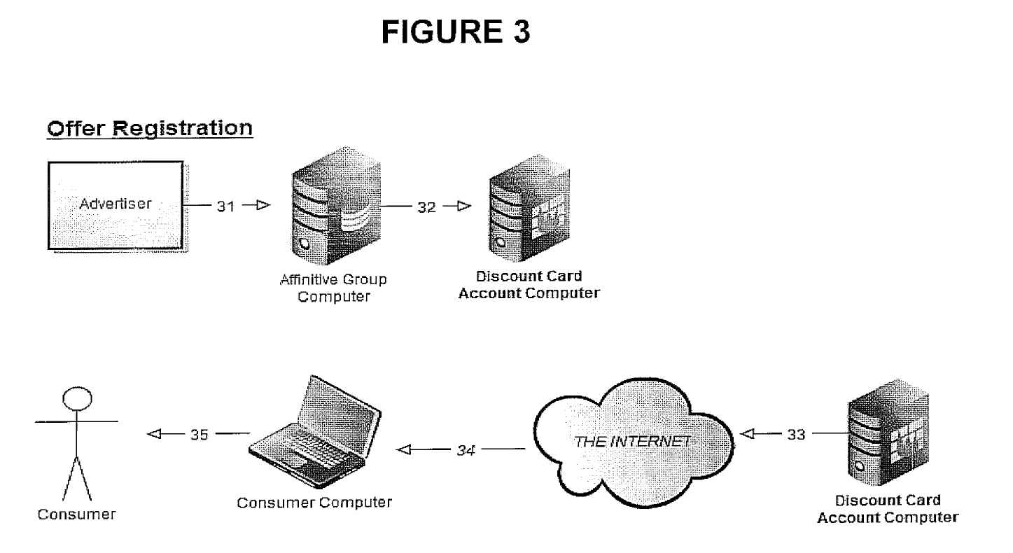

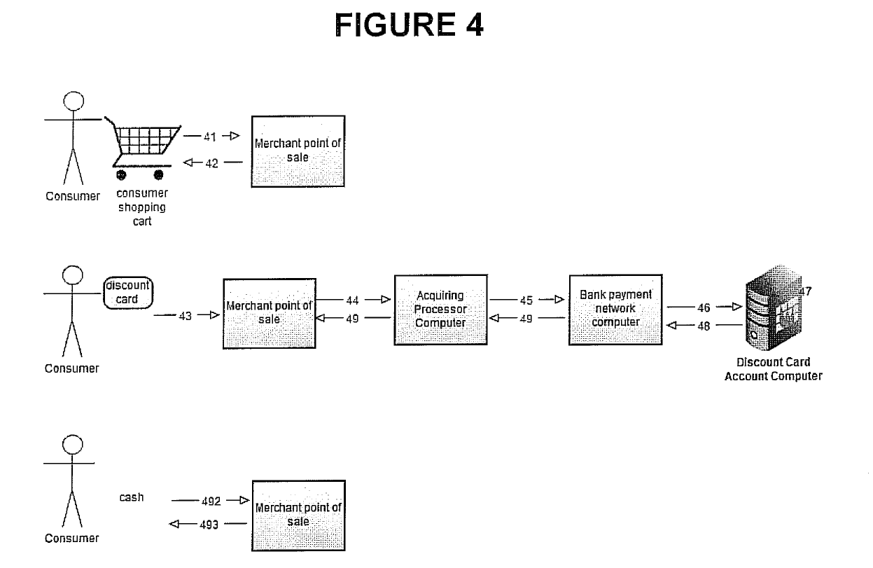

Turning now to the figures which illustrate and exemplify the invention, in FIG. 1, 1 Discount Card Account computer loads offer with offer parameters into web site computer; 2 Consumer logs in to consumer computer; 3 Consumer views web site and requests information regarding specific merchant; 4 Consumer request is carried over the Internet to web site computer; 5 Web site computer responds via Internet with requested information, including discount offer details; 6 Consumer computer receives response and offer is presented to consumer in web site defined context; 7 Consumer elects to participate in offer by making selecting on consumer computer; 8 Consumer offer opt-in is communicated by Consumer Computer via Internet; 9 Web Site computer receives consumer instructions; 10 Discount offer is registered to appropriate consumer on discount card account system pursuant to electronic instructions sent by Web Site computer; 11 Discount Card Account Computer System responds with confirmation; 12 Confirmation is delivered to consumer computer from Web Site computer via Internet; 13 Consumer offer now usable on Consumer's Discount Card. Turning now to FIG. 2, 21 Advertisement, including information about discount offers is delivered; 22 Consumer watches advertisement on TV, which includes relevant information about offer, for example, visit us online at www.nbctvoffers.com or text 1234 to 555nbctv to register for the offer on your NBC Discount Card; 23 Consumer sends text 1234 to 555nbctv.com; 24 Text message is delivered to Mobile Messaging Aggregator; 25 Mobile Messaging Aggregator sends message to Discount Card Account Computer; 26 Discount Card Account Computer identifies consumer by mobile phone number and registers the appropriate offer for that consumer; 27 Discount Card Account Computer sends confirmation message intended for consumer to Mobile Messaging Aggregator; 28 Mobile Messaging Aggregator delivers confirmation to appropriate mobile carrier and to consumer's mobile phone. FIG. 3 shows 31 Advertiser notifies affinity group of desire to offer affinity group members a discount offer; 32 Affinity group accepts offer and notifies Discount Card Account Computer that all Affinity Group members are eligible to receive the advertised discount by using the Discount Card; 33 Discount Card Account Computer sends email notification to affinity group member; 34 Email delivered via Internet to consumer computer; 35 Consumer views email and sees that discount is now available via Discount Card. FIG. 4 shows 41 Consumer shops at participating merchant and purchases a shopping cart of goods; 42 Merchant point of sale system calculates the total amount due from the consumer and communicates the total to the consumer, for example $60 total bill for 6 items; 43 Consumer swipes Discount Card at Merchant Point of Sale system; 44 Merchant Point of Sale recognizes Discount Card as bank payment network card and sends transaction to acquiring processor seeking authorization approval for $60 purchase; 45 Acquiring processor recognizes the Bank Identification Number (BIN) and sends the $60 authorization request to the appropriate bank payment network; 46 Bank payment network computer routes the $60 authorization request to the Discount Card Account Computer; 47 Discount Card Account Computer identifies Discount Card Account and reviews all eligible offer criteria to determine eligibility and determines $5 discount is available on a minimum purchase of $50; 48 Discount Card Account Computer sends partial approval response for $5 to bank payment network computer; 49 Bank payment network computer routes $5 partial approval to acquiring processor; 491 Acquiring processor routes $5 partial approval to merchant point of sale system, which then requests the consumer to pay the remaining $55 to complete the purchase; 492 Consumer hands clerk $55 in cash to complete the purchase; 493 Merchant point of sale system records the tender amount, completes purchase and receipt is provided to consumer.

Many modifications and variations of the present invention are possible in light of the above teachings. It is therefore to be understood that within the scope of the appended claims, the invention may be practiced otherwise then as specifically described. The preferred embodiments described herein detail for illustrative purposes are subject to many variations in structure and design. It should be emphasized, however, that the present invention is not limited to the particular embodiments shown and described. Rather, the principles of the present invention can be used with a variety of configurations and structural arrangements. It is understood that various omissions, substitutions of equivalents are contemplated as circumstance may suggest or render expedient, but is intended to cover the application or implementation without departing from the spirit or scope of the claims of the present invention.

Indeed, this invention may be embodied in other forms or carried out in other ways without departing from the spirit or essential characteristics thereof. The present disclosure is therefore to be considered as in all respects illustrative and not restrictive, the scope of the invention being indicated by the appended Claims, and all changes which come within the meaning and range of equivalency are intended to be embraced therein.

I claim:

1. A system for providing a discount card, the system comprising: a first computer associated with a discount card account system defining a discount card account system computer, the discount card account system computer having memory, associated with an electronic communications network and in communication with a bank payment network, and positioned to manage an account associated with at least one discount card; and a computer program product associated with the discount card account computer, stored on a tangible computer memory media, operable on a computer, and used to manage discount card transactions, the computer program product comprising a set of instructions that, when executed by the computer, cause the computer to perform the operations of: processing of merchant discounts, offers and promotions for at least one discount card by the discount card account computer; the discount, offer and promotion information being received by the discount card account computer from a second computer associated with a web site defining a web site computer; the discount, offer and promotion being associated by the discount card account system with the correct consumer discount card account and the correct offer campaign; authorizing purchase requests to use at least one discount cards as payment for the consumer purchase from a merchant via a bank payment network using an authorization-only BIN by a discount card account system; such authorization response being an approval for a partial amount that is less than the full amount of the consumer purchase, such amount that is equal to the amount of a qualifying discount, offer or promotion at the specific merchant; debiting the discount card account in the discount card account system for the appropriate amount corresponding to approved discounts, offers and promotions; and performing a proprietary, non-bank network based financial settlement process for all relevant funds requirements, fees and other financial considerations as established between the discount card program administrator and participating merchants.

2. The system according to claim 1, wherein the discount card comprises an alternative consumer identifier capable of originating a POS authorization request at a merchant point of sale system and connecting to the discount card account system for authorization.

3. The system according to claim 1, wherein the discount card further comprises a financial BIN and is capable of participating in the bank payment network and settling all approved transactions from an account at a bank associated with the discount card program administrator.

4. The system according to claim 1, wherein the offer is provided by a third party other than the redeeming merchant and wherein the third party provides funds for payment for goods delivered pursuant to a transaction approved by the discount card account system.

5. The system according to claim 1, wherein the discount card further comprises indicia of a partner brand.

6. The system according to claim 1, wherein the discount card account system receives a partial approval authorization request from the merchant point of sale system.

7. The system according to claim 1, wherein the discount card account system further comprises (a) receiving information regarding purchased products; (b)recording purchased product information in association with the discount card account; and (c) matching at least one product with any corresponding available offer for the discount card account.

8. The system according to claim 1, further comprising a computer program capable of managing discount card transactions and authorizing purchase requests to use the discount card as payment for a purchase from a seller facilitated by a bank payment network by a discount card account computer wherein the approval response is a partial approval with a value of $0, which is used to track consumer purchasing activity and deliver an approval to the seller.

9. The computer program according to claim 8, further comprising partial approval of a value greater than zero but less than the purchase amount.

10. A method of creating a network of merchants that share product information with a discount card program administrator comprising the steps of (a) processing discount card transactions; (b) providing the discount card account system with discount card mediated product purchase information; (c) recording product purchase information and associating the information with a specific discount card account; (d) calculating discounts for specific product purchases; and (e) calculating merchant commissions based on product purchase information provided to the discount card account system.

11. The method of claim 10, wherein the product information is provided through the bank payment network and received and used by the discount card account system.

12. The method of claim 10 further comprising the steps of (a) identifying the discount card account number as a unique identifier; (b) associating the unique identifier with prior product purchase history information; and (c) providing the information to the discount card account system.

13. The method of claim 10, wherein the merchant provides product information to a bank payment network.

14. A system for providing a discount card that is used by groups of consumers, comprising (a) a first computer associated with a discount card account system defining a discount card account system computer, the discount card account system computer having memory, associated with an electronic communications network and in communication with a bank payment network, and positioned to manage an account associated with at least one discount card; (b) a computer program product associated with the discount card account computer, used to manage discount card transactions, the computer program product comprising a set of instructions that, when executed by the computer, cause the computer to perform the operations of: processing merchant discounts, offers and promotions associated with at least one discount card by the discount card account computer; the discount, offer or promotion information being received by the discount card account computer from a second computer associated with a web site defining a web site computer; the discount, offer and promotion being associated by the discount card account system with the correct consumer discount card account and the correct offer campaign; the discount, offer and promotion being somehow connected to the behavior of a group of consumers, wherein all the consumers participating in the group receive the same offer and the nature of the offer itself is somehow dependent on the group participation; authorizing purchase requests to use one or more discount cards as payment for the consumer purchase from a merchant via a bank payment network using an authorization-only BIN by a discount card account system; such authorization response being an approval for a partial amount that is less than the full amount of the consumer purchase, such amount that is equal to the amount of a qualifying discount, offer or promotion at the specific merchant; debiting the discount card account in the discount card account system for the appropriate amount corresponding to approved discounts, offers and promotions.

15. The method according to claim 14, wherein the total purchase amount for the consumer purchase at the participating retailer is made by the discount card account computer through the participating bank payment network for all purchases that meet qualifying criteria of the discount offered.

16. The computer-implemented method according to claim 14, wherein the discount card is prepaid in some portion.

17. The computer-implemented method according to claim 14, wherein the discount amount increases with the number of participating members of a group.

18. The computer implemented method according to claim 14, further comprising offering benefit increases with the number of participating members of a group.

19. The method according to claim 14, wherein authorization requests are made using a BIN on the bank payment network.
